(19) United States
(12) Patent Application Publication
(10) Pub. No.: US 2006/0022818 A1
(43) Pub. Date: Feb. 2, 2006

(54) System for tracking individuals

(76) Inventor: Harri Piltonen, Varjakka (FI)

Correspondence Address: YOUNG & THOMPSON, 745 SOUTH 23RD STREET, 2ND FLOOR, ARLINGTON, VA, 22202, US

(21) Appl. No.: 11/189,751

(22) Filed: Jul. 27, 2005

Related U.S. Application Data
(63) Continuation of application No. PCT/FI04/00030, filed on Jan. 21, 2004.

(30) Foreign Application Priority Data
Jan. 27, 2003 (FI) 20030121

(51) Int. Cl. G08B 1/08; G08B 5/22

(52) U.S. Cl. 340/539.13; 340/825.49

(57) ABSTRACT

In a tracking system especially for persons suffering from a memory disorder, each tracked person is fitted with a portable personal monitoring unit containing a receiver component and a transmitter component connected by radio to an alarm unit. The monitoring unit send messages to the alarm unit. The alarm unit sends the messages onward to a monitoring room. In a low-current standby state, only the receiver component operates. In an operating state, the transmitter component also operates. The monitoring unit is in the operating state when the monitored person has exited from the operating area, and otherwise in the standby state. The monitoring device enters the standby state or operating state automatically by means of activating and deactivating units situated along passageways leading to the operating area, operating by inductive data transmission. The system also includes a locating unit for locating a monitoring unit in the operating state.

### CROSS REFERENCE TO RELATED APPLICATIONS

This application is a continuation of International Application No. PCT/FI2004/000030 filed on Jan. 21, 2004, which designated the United States of America and Finnish Application No. 20030121, filed on Jan. 27, 2003, the entire contents of which are hereby incorporated by reference.

The present invention relates to a system for tracking individuals, which comprises a monitoring unit carried by each monitored person, at least one alarm unit connected by radio to said monitoring units and a monitoring room connected by means of a data transmission network to said alarm unit.

The elderly population in particular suffers considerably from various degrees of memory disorders. Persons suffering from a mild memory disorder are capable of caring for their own daily activities themselves and are able to live at home. Persons suffering from a more serious memory disorder usually live in old-age homes or nursing homes. Persons with a memory disorder can usually get along well in their own familiar living environment either independently or with the help of nursing staff. Such persons cannot, however, get along alone outside their familiar living environment, for which reason it is necessary to monitor and limit the free movement of persons with a memory disorder for the sake of their own security. If for some reason a person with a memory disorder should get lost outside his own living environment, it is important to be able to locate and find him quickly.

Various types of technical systems have been developed to monitor the passage of and locate persons with a memory disorder. From patent publication FI 92969 is known a health monitoring device which includes a transmitter unit attached to the wrist and a separate receiver unit. If the wristband moves too far away from the receiver unit, an alarm is produced immediately. The alarm can be transferred onward from the receiver to a centralized alarm reception point, for example, by means of a security phone. From patent publication U.S. Pat. No. 5,714,932 is known a security system which includes a central unit and several portable transmitters fitted with individual identification codes and connected by radio to the central unit. When the level of a signal sent by the transmitter drops below a specified threshold value the central unit produces an alarm. The central unit also includes direction finding and distance measuring means with which the direction and distance of the transmitter from the central unit can be determined.

In said equipment the transmitter carried by the monitored person continuously sends a radio signal to the receiver unit. For this reason their power consumption is high. Therefore, keeping the transmitter in operating condition requires equipping the transmitter with a powerful battery and sufficiently frequent battery replacement.

Another weakness of the equipment described above is that the alarm threshold in said equipment is inaccurate because it is directly defined by the strength of the radio signal between the transmitter and the receiver. Said security system cannot, for example, differentiate whether a monitored person is securely inside a building or near the building on the outside.

The purpose of the present invention is to present an improved system for monitoring the passage of and locating especially a person with a memory disorder With a system according to the present invention it is possible to significantly reduce the disadvantages and weaknesses of systems according to the prior art.

A system according to the present invention is characterized by what is presented in the independent claim. Certain advantageous embodiments of the present invention are presented in the dependent claims.

The present invention relates to a tracking system especially for persons suffering from a memory disorder. In a system according to the present invention each person belonging within the sphere of the system is fitted with a portable personal monitoring unit containing a receiver component and a transmitter component. By means of the transmitter component the monitoring unit can send messages by radio to an alarm unit included in the system. The monitoring unit sends a message to the alarm unit, for example, when a person belonging within the sphere of monitoring exits from a permissible operating area specified for said person. The alarm unit sends the messages it has received onward to a monitoring room included in the system, where necessary measures, such as searches, are undertaken on the basis of the received messages. The basic principle of a system according to the present invention is that the monitoring unit can be set into a standby state, whereupon only the receiver component is in operation, or an operating state, whereupon the transmitter component is also in operation. According to the present invention the monitoring unit is set into an operating state that sends radio messages only when the monitored person has exited from the permissible operating area. When said person is within the permissible operating area the monitoring unit is in a standby state, whereupon its current consumption is very low.

In one advantageous embodiment of the present invention each monitoring unit is equipped with a unique identification code which is linked to messages sent by said monitoring unit.

In another advantageous embodiment of the present invention the system also comprises at least one activating unit which gives activation commands and a deactivating unit which gives deactivation commands, with which a monitoring unit is set into a standby state or an operating state. The activating and deactivating units are advantageously located along a passageway leading to the permissible operating area.

In a third advantageous embodiment of the present invention the transfer of activation and deactivation commands from the activating and deactivating unit to the monitoring unit happens by means of inductive data transmission.

In a fourth advantageous embodiment of the present invention the system also comprises a locating unit to locate a monitoring unit within the operating area.

An advantage of the system according to the present invention is that the current consumption of the monitoring unit is very low. For this reason the monitoring unit stays in operating condition without maintenance measures for a very long time.

Another advantage of the present invention is that the “permissible” operating area of a monitored person can be specified very accurately, for example, in the interior of a specific building.

Yet another advantage of the present invention is that it has diverse applications. In addition to passage monitoring, the device can also be used as a staff security device in such institutions where the staff may be the object of an attack.

The present invention is described in detail below, with reference to the enclosed drawings, where

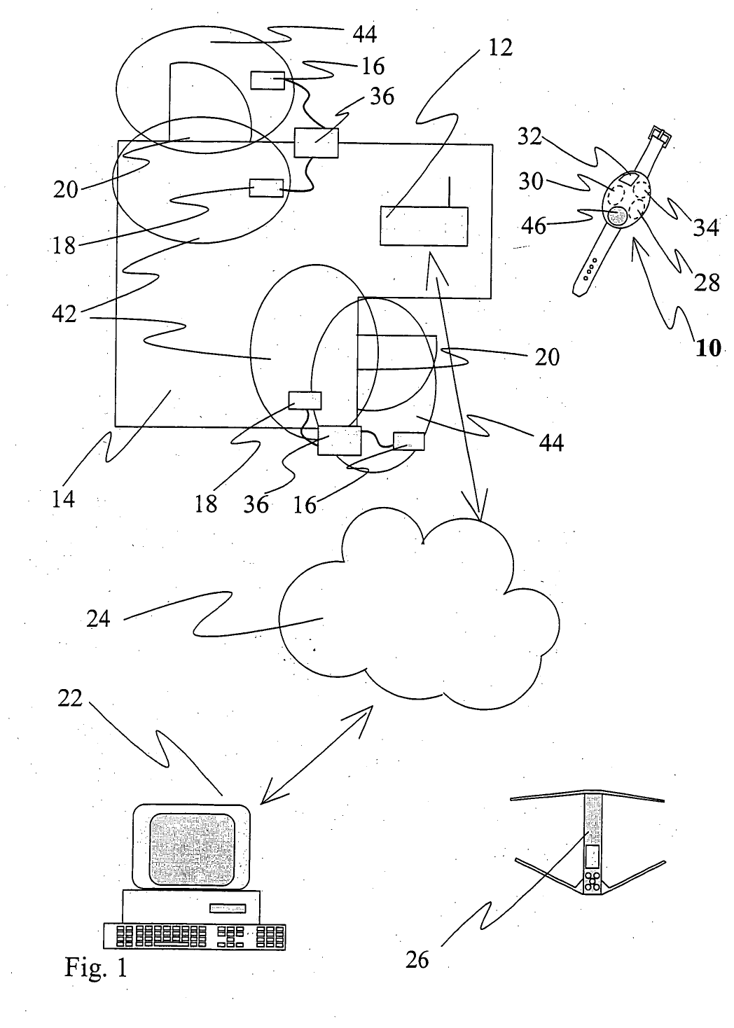

FIG. 1 shows an exemplary presentation of a system according to the present invention and a diagram in principle of separate components belonging to said system and

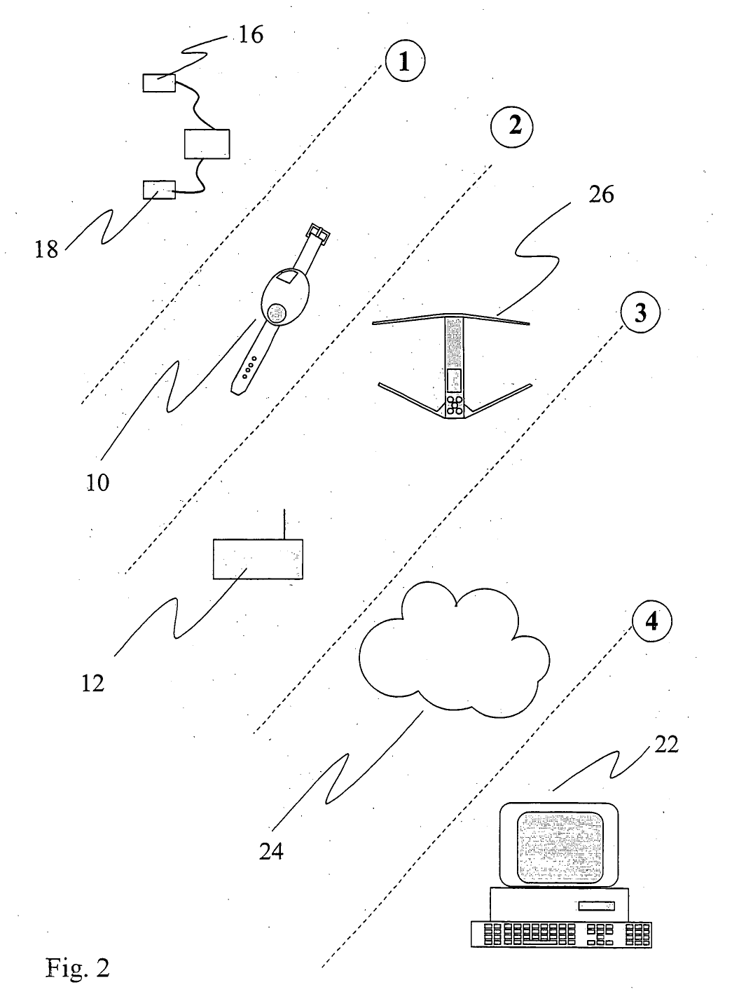

FIG. 2 presents data transmission interfaces in a system according to the present invention.

FIG. 1 shows an exemplary presentation of a passage monitoring and locating system according to the present invention and a diagram in principle of separate components belonging to said system. A system according to the present invention comprises a monitoring unit 10 carried by a monitored person, an alarm unit 12 situated in or near said person's operating area 14, and activating units 16 and deactivating units 18 installed in pairs along the operating area's passageways 20, whose operation is controlled by means of a common control unit 36. In this presentation an operating area refers to an area within which a monitored person may freely move without triggering an alarm. In the case of a monitored person with a memory disorder, said operating area typically is, for example, said person's own home, an old-age home or a nursing home. The operating area may be limited to the interior of a building or it may also include a fenced-in yard of the building. The operating area's passageways refer to routes along which one travels to and from the area, meaning in practice the outer doors of the building and the gates in the fence around the yard. A system according to the present invention also comprises a monitoring room 22 connected to the alarm unit 12 by means of a data transmission network 24 and a locating unit 26 for locating the monitoring units 10.

The monitoring unit 10 is an electrical battery-operated device which includes an inductive receiver component 28 and a transmitter component 30. The monitoring unit is advantageously shaped into a wristband that is fastened to the monitored person's wrist. The monitoring unit can be in two different states: a standby state or a operating state. In the standby state only the unit's receiver component is in operation, whereupon the current consumption of the entire monitoring unit is very low. Correspondingly, in the operating state the monitoring unit's transmitter component is also in operation, whereupon the current consumption of the entire unit is naturally higher. In the normal operating situation of the system, where the monitored person stays within the operating area, the monitoring unit is in the standby state and therefore consumes very little energy. The monitoring unit contains an indicator 32 which indicates at regular intervals, for example by means of a light and/or audible signal every half hour, that the unit is in operating condition. Advantageously said indicator is a light emitting diode, or a LED indicator. The transmitter component of the monitoring unit is programmed to turn on at regular intervals, advantageously every 1-2 hours, in order to test the condition of the battery 34. If the battery voltage is too low, the transmitter component sends battery warning messages to the alarm unit 12 at random intervals. Advantageously, the need to replace the battery is also indicated by the indicator 32 by means of a light signal. The monitoring unit also contains a panic button 46, which causes the unit to immediately enter the operating state when pressed.

The activating unit 16 and deactivating unit 18 are data transmission signal sending devices which are situated in pairs along the passageways 20 of the operating area in such a manner that the deactivating unit is installed along the passageway within the limits of the operating area 14, for example, inside the outer door. Correspondingly, the activating unit is situated along the passageway outside the limits of the operating area, for example, outside the outer door. The operation of the units is controlled by means of a common control unit in such a manner that the activating unit 16 and deactivating unit 18 by turn, advantageously 4 times a second, send monitoring unit 10 activation and deactivation commands by means of inductive data transmission. Thus, a deactivation field 42 primarily situated within the operating area 14 and an activation field 44 primarily situated outside the operating area are created along the passageway. The activating and deactivating units are connected to the building's electrical network and they advantageously include a battery backup in case of a power failure.

The alarm unit 12 is a device which comprises a radio receiver for receiving radio messages sent by the monitoring units 10 and a transmitter/modem for transferring the messages to the monitoring room 22. The alarm unit alternately listens to the frequencies used by the monitoring units 10. Advantageously the alarm unit listens to each frequency for 1.3 seconds at a time. When the alarm unit receives a message from a monitoring unit 10, it sends the message onward to the monitoring room 22. The message advantageously includes at least the time, the identification code of the monitoring unit 10 that sent the message or the name of the person carrying the monitoring unit and the reason for the alarm, which may be a notice that the monitored person has exited from the operating area, a notice that said person has returned to the operating area, a notice that the panic button has been pressed or a notice that the battery of the monitoring unit needs to be replaced. The alarm unit is advantageously equipped with a memory, which stores the most recent alarm events and the time when they occurred. The device has a battery backup, which keeps the device in operation during brief power failures. The structure of the alarm unit represents technology according to the prior art commonly used in telecommunication technology, for which reason it is not explained in more detail in this conjunction.

The monitoring room 22 is a place where messages sent by alarm units are received. Advantageously the monitoring room comprises a computer which is continuously connected to a data transmission network 24 and which contains a database into which is stored the personal data and contact data of each carrier of a monitoring unit and the length of time that each monitored person is allowed to be absent from the operating area. In its simplest form the monitoring room may also be a mobile phone or a paging device to which alarm messages are sent. The situation data of all the monitoring units 10 connected to the system are continuously monitored in the monitoring room. Naturally, the monitoring room has a monitoring staff which continuously monitors messages arriving in the monitoring room and undertakes necessary measures on the basis of the messages. At night the messages that arrive in the monitoring room can be directed directly to, for example, a security company operating in the region, whereupon costly 24-hour monitoring can be avoided.

The passage monitoring and locating system according to the present invention functions as follows: When a monitored person is within the operating area 14, the monitoring unit 10 is in a standby state that consumes little current. If the person moves near a passageway 20, such as an outer door, the monitoring unit simultaneously enters a deactivation field 42 created by the deactivating unit 18. While in the deactivation field, the monitoring unit receives deactivation commands, so the monitoring unit remains in the standby state. If the monitored person passes through the passageway 20, he arrives in an activation field 44, where the monitoring unit 10 receives activation commands. As a result of the activation commands the monitoring unit enters the operating state and begins to sent exiting messages containing the monitoring unit's own identification code to the alarm unit. Each monitoring unit is equipped with its own unique identification code, which is always included in a message sent by the monitoring unit. Thus, it is known from the messages arriving at the alarm unit which monitoring unit they originate from. The alarm unit 12 receives the exiting message and sends the exiting message onward to the monitoring room 22 by means of the data transmission network 24. Thus, the monitoring room knows that the monitored person has exited from the operating area and can undertake necessary measures.

Activation of the monitoring unit into the operating state happens only after the monitored person has exited from the activating field. This allows the monitored person to open the outer door for a visitor, for example, without causing an alarm. If necessary, the monitoring unit may also be activated by pressing the panic button 46. The monitoring unit enters the operating state even though the panic button is pressed inside the operating area or the deactivating field. Pressing the panic button causes the monitoring unit to send alarm messages to the alarm unit, which are transferred onward to the monitoring room. A monitoring unit activated by the panic button can be deactivated by holding a magnet next to the monitoring unit until the transmissions end.

If the monitored person returns to the operating area 14, he first passes through the activating field 44 and immediately thereafter through the deactivating field 42. Thus, the monitoring unit 10 receives deactivation commands last, which cause the monitoring unit to enter the standby state. Before entering the standby state the monitoring unit sends the alarm unit a limited number of arrival messages. The alarm unit transfers the arrival messages onward to the monitoring room, where it is then known that the monitored person returned to the operating area.

Due to the messages sent by the alarm unit, the monitoring room 22 always has real-time information about whether the monitored persons are inside or outside the operating area. In the monitoring room unit it is possible to individually specify for each monitored person a period of time when said person is allowed to be absent before a search is undertaken. Thus, for example, a person with a mild memory disorder may be allowed a 3-4-hour period of absence, making it possible for said person to take care of daily business, such as getting the mail or going to the store or the bank. Correspondingly, a person suffering from serious dementia may be allowed only a five minute period of absence if it is known that he cannot get along alone at all.

If a monitored person does not return to the operating area within the allowed period of absence, the monitoring room undertakes measures to determine the location of said person. First an attempt is made to determine his location by calling the monitored person's own mobile phone (if he has one) or the phone of a person working in the operating area, such as the responsible nurse. From the monitoring room it is also possible to contact a security company operating in the region, whereupon a security guard checks the situation at the supervised site in question. If the location of the monitored person cannot be determined by means of the above measures, a search is undertaken using the locating unit 26 belonging to the system according to the present invention.

The locating unit 26 is a direction finding device with which it is possible to determine in which direction the monitoring device 10 that is sending exiting messages is located. The locating unit includes a keyboard for setting the monitored frequency channel and browsing codes and a display for presenting the number of the frequency channel, the strength of the message signal and the identification code included in the exiting message. The locating unit also includes an amplifier for adjusting the received message signal to a range that is suitable from the standpoint of successful direction finding. The direction finding method and device of the locating unit are according to a technology that in itself is known, which is commonly used in dog radars manufactured by Tracker Oy, for example.

A system according to the present invention may include several alarm units 12, which are connected to the same monitoring room 22 by means of a data transmission network 24. Thus, with one monitoring room it is possible to centrally monitor several different operating areas 14. In one advantageous embodiment of the present invention the system uses one hundred frequencies and one alarm unit has five frequencies in use at one time. One hundred different identification codes can be programmed into one alarm unit, meaning it can transfer messages from one hundred different monitoring units 10 to the monitoring room 22. The monitoring units vary their message transmission intervals, which makes it possible to create several simultaneous alarms on the same frequency channel.

FIG. 2 shows an exemplary presentation of data transmission at interfaces between various components of a system according to the present invention. Wireless, advantageously inductive data transmission is used at the interface 1 between the activating unit 16 and deactivating unit 18 and the monitoring unit 10. Advantageously the data transmission is implemented using a frequency of 4.8 kHz. The transmitted bit stream is comprised of a synchronizing part followed by an actual data part.

The interface between the monitoring unit 10 and the alarm unit 12 and between the monitoring unit and the locating unit is indicated with reference number 2 in FIG. 2. Advantageously, data transmission at said interface uses radio traffic with a frequency of 433 MHz. Depending on country-specific limitations, the monitoring unit advantageously uses a radio signal transmission power of either 10 mW (EU countries) or 25 mW (Finland, Sweden), but also other transmission powers are possible.

The interface between the alarm unit and the data transmission network 24 is indicated with reference number 3 and the interface between the data transmission network and the monitoring room with reference number 4. Data transmission at said interfaces may take place using either a wireless or a wired connection. The data transmission network itself may be wired, such as a telephone network or Internet network, or wireless, for example a mobile phone network.

Certain advantageous embodiments of a system according to the present invention are described above. The present invention is especially well suited to monitoring the passage of and locating persons with a memory disorder, but it can also be used, for example, to monitor the movement of little children in homes and day care centers. In an advantageous embodiment of the present invention the system according to the present invention is situated in a hospital environment. In said embodiment the monitoring units 10 included in the system are given to patients requiring monitoring and also to members of the hospital staff who in their work may be the object of attacks by violent patients. In such a case a person who has become the object of an attack can call for help by pressing the panic button 46 of the monitoring unit. In such a case the alarm is transferred to the monitoring room via an alarm unit in the patient's room or the ward, whereupon in the monitoring room 22 it is possible to direct help to the correct place on the basis of the location of the alarm unit 12. If the alarm has come from a monitoring unit belonging to a member of the nursing staff it is known in the monitoring room that a violent incident is in question, whereupon a security guard can be alerted to the site.

It is also possible to easily arrange an indoor personal locating possibility in a passage monitoring system according to the present invention by situating deactivating units 18 in suitable places, for example in the hallways and rooms of a hospital. Each deactivating unit can be programmed to send its own unique locating code, which is stored in a monitoring unit's 10 memory whenever a monitored person passes by the deactivating unit. If the monitored person presses the panic button 46 of the monitoring unit, the monitoring unit sends the identification code of the most recently passed deactivating unit in conjunction with the alarm message sent to the monitoring room. Thus, in the monitoring room it is known exactly where the emergency situation is.

Indoor locating of monitored persons can also be realized in such a manner that the monitoring unit 10 is programmed to send a locating message to the monitoring room whenever the monitoring receives a new locating code that differs from the previous locating code sent by a deactivating unit 18. Surveillance receivers can be situated inside the building, which transfer the locating message to the monitoring room. Thus in the monitoring room the location of all the monitored persons is always known in real time. The locating message can advantageously be sent at minimum power, whereupon the current consumption of the monitoring unit remains low.

The system according to the present invention can be used in the manner described above to also enhance the security of the staff in various offices where the staff may need to meet violent clients.

The present invention is not limited to the described embodiments. The inventive idea may be applied in numerous ways to the extent allowed by the enclosed claims.

1. A system for tracking individuals, which comprises a monitoring unit (10) carried by each monitored person, which monitoring unit contains a receiver component (28) and a transmitter component (30) and which monitoring unit is settable into a standby state, where only the receiver component is in operation, and an operating state, where both the receiver component and transmitter component are in operation, at least one alarm unit (12) contacted by radio to said monitoring units and a monitoring room (22) connected by means of a data transmission network (24) to said alarm unit, characterized in that it comprises at least one activating unit (16) that gives activation commands and at least one deactivating unit (18) that gives deactivation commands, which activating unit (16) and deactivating unit (18) are arranged along a passageway (20) leading to an operating area (14) limited by borders to create around themselves an activating field (44) and a deactivating field (42) along the passageway in order to set said monitoring unit (10) into a standby state or an operating state.

2. The system according to claim 1, characterized in that transmission of data from the activating unit (16) and deactivating unit (18) to the monitoring unit (10) takes place by means of wireless data transmission.

3. The system according to claim 1, characterized in that the activating field (44) is created primarily outside said operating area and the deactivating field (42) is created primarily inside said operating area.

4. The system according claim 1, characterized in that the activating unit (16) and deactivating unit (18) are situated along the passageway (20) in such a manner that passing through the passageway reveals the direction of travel of a person carrying a monitoring unit (10).

5. The system according to claim 1, characterized in that the deactivating unit (18) is arranged to send a unique locating code, and that the monitoring unit contains a memory for storing the received locating code.

6. The system according to claim 5, characterized in that a message sent by the monitoring unit (10) includes a locating code stored in the unit's memory.

7. The system according to claim 1, characterized in that the monitoring units (10) are equipped with a unique identification code that is linked to messages sent by the monitoring unit.

8. The system according to claim 1, characterized in that the monitoring unit (10) also contains a panic button (46) for setting the monitoring unit in the operating state.

9. The system according to claim 1, characterized in that the monitoring unit also contains an indicator (32) for indicating the operating condition of the monitoring unit.

10. The system according to claim 1, characterized in that the monitoring unit (10) is shaped into a wristband that is fastened to the wrist of a monitored person.

11. The system according to claim 1, characterized in that the system also comprises a locating unit (26) for locating a monitoring unit (10) in the operating state.

12. The system according to claim 2, characterized in that the activating field (44) is created primarily outside said operating area and the deactivating field (42) is created primarily inside said operating area.

13. The system according claim 2, characterized in that the activating unit (16) and deactivating unit (18) are situated along the passageway (20) in such a manner that passing through the passageway reveals the direction of travel of a person carrying a monitoring unit (10).

14. The system according claim 3, characterized in that the activating unit (16) and deactivating unit (18) are situated along the passageway (20) in such a manner that passing through the passageway reveals the direction of travel of a person carrying a monitoring unit (10).

15. The system according to claim 2, characterized in that the deactivating unit (18) is arranged to, send a unique locating code, and that the monitoring unit contains a memory for storing the received locating code.

16. The system according to claim 3, characterized in that the deactivating unit (18) is arranged to send a unique locating code, and that the monitoring unit contains a memory for storing the received locating code.

17. The system according to claim 4, characterized in that the deactivating unit (18) is arranged to send a unique locating code, and that the monitoring unit contains a memory for storing the received locating code.

18. The system according to claim 2, characterized in that the monitoring units (10) are equipped with a unique identification code that is linked to messages sent by the monitoring unit.

19. The system according to claim 3, characterized in that the monitoring units (10) are equipped with a unique identification code that is linked to messages sent by the monitoring unit.

20. The system according to claim 4, characterized in that the monitoring units (10) are equipped with a unique identification code that is linked to messages sent by the monitoring unit.
